(19) United States
(12) Patent Application Publication
(10) Pub. No.: US 2023/0101949 A1
(43) Pub. Date: Mar. 30, 2023

(54) DEVICE AND METHOD FOR SHARED MEMORY PROCESSING AND NON-TRANSITORY COMPUTER STORAGE MEDIUM

(71) Applicant: GUANGDONG OPPO MOBILE TELECOMMUNICATIONS CORP., LTD., Dongguan (CN)

(72) Inventor: Jun LIU, Dongguan (CN)

(21) Appl. No.: 18/063,298

(22) Filed: Dec. 8, 2022

Related U.S. Application Data
(63) Continuation of application No. PCT/CN2020/106648, filed on Aug. 3, 2020.

(51) Int. Cl. G06F 12/1072

(52) U.S. Cl. CPC G06F 12/1072; G06F 2212/656

(57) ABSTRACT

A device for shared memory processing is provided in implementations of the disclosure. The device for shared memory processing includes a set of shared memory units, a set of processing units, and a set of global clock synchronizers. Each shared memory unit corresponds to one global clock synchronizer and is coupled with K processing units via the corresponding global clock synchronizer, and the coupled K processing units perform conflict-free memory access to the shared memory unit during one instruction cycle of the corresponding global clock synchronizer. One instruction cycle of each global clock synchronizer includes N clocks, K is less than or equal to N, and K and N are integers greater than zero. A method for shared memory processing and a non-transitory computer storage medium are also provided.

### CROSS-REFERENCE TO RELATED APPLICATION(S)

This application is a continuation of International Application No. PCT/CN2020/106648, filed Aug. 3, 2020, the entire disclosure of which is incorporated herein by reference.

### TECHNICAL FIELD

Implementations of this disclosure relates to the field of memory management technology, and particularly to a device and method for shared memory processing and a non-transitory computer storage medium.

### BACKGROUND

Modern wireless mobile communication systems support great bandwidth and multiple carriers, and have various carrier processing capacities. Therefore, it is required that a system for signal processing not only has high processing capacity, but also can flexibly and rapidly make changes according to various capacity levels. However, on one hand, the current system for signal processing has limited processing capacity, on the other hand, there may be access conflicts when multiple processing units access a shared memory, which reduces processing efficiency.

### SUMMARY

Implementations of the disclosure provide a device and method for shared memory processing and a non-transitory computer storage medium.

In a first aspect, a device for shared memory processing is provided in implementations of the disclosure. The device for shared memory processing includes a set of shared memory units, a set of processing units, and a set of global clock synchronizers. Each shared memory unit corresponds to one global clock synchronizer and is coupled with K processing units via the corresponding global clock synchronizer, and the coupled K processing units perform conflict-free memory access to the shared memory unit during one instruction cycle of the corresponding global clock synchronizer. One instruction cycle of each global clock synchronizer includes N clocks, K is less than or equal to N, and K and N are integers greater than zero.

In a second aspect, a method for shared memory processing is provided in implementations of the disclosure and applicable to a device for shared memory processing. The device for shared memory processing includes a set of shared memory units, a set of processing units, and a set of global clock synchronizers. Each shared memory unit corresponds to one global clock synchronizer and is coupled with K processing units via the corresponding global clock synchronizer. The method for shared memory processing includes acquiring a status signal of each of the K processing units when the coupled K processing units respectively transmit access requests to the corresponding shared memory unit; determining a count value of a global counter in the corresponding global clock synchronizer; determining a to-be-responded processing unit in a current clock, according to the status signal and the count value determined; and accessing the shared memory unit in the current clock, according to the to-be-responded processing unit determined. One instruction cycle of each global clock synchronizer includes N clocks, K is less than or equal to N, and K and N are positive integers.

In a third aspect, a non-transitory computer storage medium storing a computer program is provided in implementations of the disclosure. The computer program is executed by a device for shared memory processing. The device for shared memory processing includes a set of shared memory units, a set of processing units, and a set of global clock synchronizers. Each shared memory unit corresponds to one global clock synchronizer and is coupled with K processing units via the corresponding global clock synchronizer. The computer program is executed by the device for shared memory processing to perform acquiring a status signal of each of the K processing units when the coupled K processing units respectively transmit access requests to the corresponding shared memory unit; determining a count value of a global counter in the corresponding global clock synchronizer; determining a to-be-responded processing unit in a current clock, according to the status signal and the count value determined; and accessing the shared memory unit in the current clock, according to the to-be-responded processing unit determined. One instruction cycle of the global clock synchronizer includes N clocks, K is less than or equal to N, and K and N are positive integers.

### BRIEF DESCRIPTION OF THE DRAWINGS

FIG. 1 is a schematic structural diagram of a device for shared memory processing provided in implementations of the disclosure.

FIG. 2 is a schematic structural diagram of another device for shared memory processing provided in implementations of the disclosure.

FIG. 3 is a schematic diagram illustrating working principles of a global clock synchronizer provided in implementations of the disclosure.

FIG. 4 is a schematic structural diagram of a system for signal processing provided in implementations of the disclosure.

FIG. 5 is a schematic structural diagram of a modem provided in implementations of the disclosure.

FIG. 6 is a schematic flow chart of a method for shared memory processing provided in implementations of the disclosure.

### DETAILED DESCRIPTION

In order for more comprehensive understanding of features and technical solutions of implementations of the disclosure, the following will describe in detail implementations of the disclosure with reference to accompanying drawings. The accompanying drawings are merely intended for illustration rather than limitation on implementations of the disclosure.

Modem is short for modulator and demodulator. Specifically, a modem is an electronic device that can realize modulation and demodulation required for communication. At a transmitting end, a modem is configured to modulate digital signals generated by a computer serial interface into analog signals that can be transmitted on telephone cables. At a receiving end, a modem is configured to convert analog signals input to a computer into corresponding digital signals and transmit the digital signals to a computer interface. In a personal computer, a modem is often configured to exchange data and programs with other computers, and access online information service programs, etc. Here, the modulation refers to conversion of digital signals into analog signals transmitted on telephone cables, and the demodulation refers to conversion of analog signals into digital signals, which is collectively called modem.

Modern wireless mobile communication systems support great bandwidth and multiple carriers, and have various carrier processing capacities. Therefore, it is required that a system for signal processing not only has high processing capacity, but also can flexibly and rapidly make changes according to various capacity levels. Therefore, in implementations of the disclosure, an efficient and flexible signal processing sub-system is provided, which is crucial to design of a modem.

The following will describe in detail implementations of the disclosure with reference to the accompanying drawings.

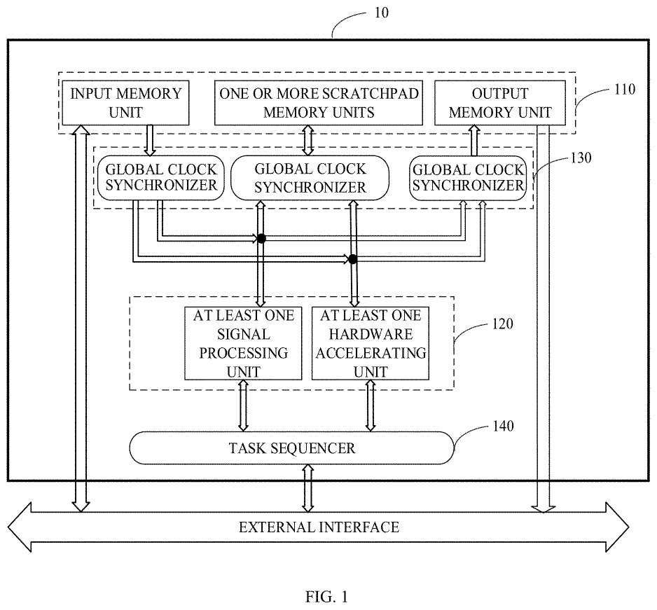

Referring to FIG. 1, FIG. 1 is a schematic structural diagram of a device for shared memory processing provided in implementations of the disclosure. As illustrated in FIG. 1, a device 10 for shared memory processing may include a set of shared memory units 110, a set of processing units 120, and a set of global clock synchronizers 130. Each shared memory unit corresponds to one global clock synchronizer and is coupled with K processing units via the corresponding global clock synchronizer, and the coupled K processing units perform conflict-free memory access to the shared memory unit during one instruction cycle. One instruction cycle of the global clock synchronizer includes N clocks, K is less than or equal to N, and K and N are integers greater than zero.

In some implementations, as illustrated in FIG. 1, the set of shared memory units 110 may include at least three shared memory units, and the at least three shared memory units may include an input memory unit, an output memory unit, and one or more scratchpad memory units.

Correspondingly, the set of global clock synchronizers 130 may include at least three global clock synchronizers. The input memory unit can be coupled with multiple processing units in the set of processing units 120 via a corresponding global clock synchronizer. The output memory unit can be coupled with multiple processing units in the set of processing units 120 via a corresponding global clock synchronizer. The one or more scratchpad memory units can also be coupled with multiple processing units in the set of processing units 120 via a corresponding global clock synchronizer.

It is to be noted that the number of the processing units coupled with each shared memory unit is related to the instruction cycle of the global clock synchronizer. Assuming that one instruction cycle includes four clocks, the number of the processing units coupled with each shared memory unit does not exceed four. In the case, for a certain shared memory unit, each of corresponding processing units accesses the shared memory unit during one of four different clocks of one instruction cycle, and thus there will be no memory access conflict.

It is to be further noted that, in some implementations, as illustrated in FIG. 1, the input memory unit adopts a dual-port structure, and the output memory unit adopts a dual-port structure. The input memory unit may include a first input-port and a second input-port, where the first input-port is coupled with an external interface, and the second input-port is coupled with K1 processing units via a corresponding global clock synchronizer. The output memory unit may include a first output-port and a second output-port, where the first output-port is coupled with the external interface, and the second output-port is coupled with K2 processing units via a corresponding global clock synchronizer.

The external interface herein may be a network on chip (NOC), advanced high performance bus (AHB), or multi core-interconnect, etc., which is not limited in implementations of the disclosure.

In implementations of the disclosure, the external interface generally adopts the NOC. The NOC is a new on-chip communication method of a system on chip (SOC), which is the main component of multi-core technology. In addition, the NOC is a new on-chip communication method, and performance of the NOC is significantly superior to performance of traditional bus systems.

In other words, the input memory unit and the output memory unit both are dual-port random access memories (RAMs). One port (the first input-port or the first output-port) is directly coupled with the NOC, and the other port (the second input-port or the second output-port) is coupled with specific processing units in the device 10 for shared memory processing. The NOC may carry various system data and has relatively strong randomness, such that data interaction between outside and inside of the device 10 for shared memory processing via direct memory access (DMA) may be interrupted at any time. However, with dual-port RAM design in implementations of the disclosure, data reading and data writing of the processing unit in the device 10 for shared memory processing can be isolated from interaction with external data, and thus it can be ensured that data reading and data writing of the processing unit in the device 10 for shared memory processing are not affected by interaction with external data.

In some implementations, as illustrated in FIG. 1, the set of processing units 120 may include at least one signal processing unit and/or at least one hardware accelerating unit.

The signal processing unit herein may be a vector digital signal processor (VDSP), and the hardware accelerating unit may be a hardware accelerator (HWA). Both the signal processing unit and the hardware accelerating unit belong to data processing units. The signal processing unit and the hardware accelerating unit are both responsible for reading data from a corresponding shared memory unit, processing read data, and writing processing results to the shared memory unit.

It is to be further noted that, for the set of processing units 120, to adapt to an instruction cycle including N different clocks, a shared memory unit is coupled with specific processing units, such that it can be ensured that each shared memory unit can be accessed by N processing units at most, and the N processing units are synchronous in timing sequence, thereby realizing conflict-free access of the N processing units to the shared memory unit in N different clocks of a same instruction cycle.

Furthermore, in some implementations, as illustrated in FIG. 1, the device 10 for shared memory processing may further include a task sequencer (TS) 140. The TS 140 is coupled with the external interface and the set of processing units 120. The TS 140 is configured to receive a task message transmitted through the external interface and forward the task message to a corresponding processing unit, such as the signal processing unit or the hardware accelerating unit.

In this way, for the device 10 for shared memory processing, the most significant feature is that all processing units in the device 10 for shared memory processing can perform conflict-free memory access to the shared memory unit, and with the dual-port design, access to the shared memory unit is isolated from access of external data, such that the device 10 for shared memory processing has high processing efficiency and stable and predictable processing delay, and is easy to be extended.

In implementations of the disclosure, the set of shared memory units 110 include four shared memory units in a case where two scratchpad memory units are included. Correspondingly, the set of global clock synchronizers 130 also include four global clock synchronizers.

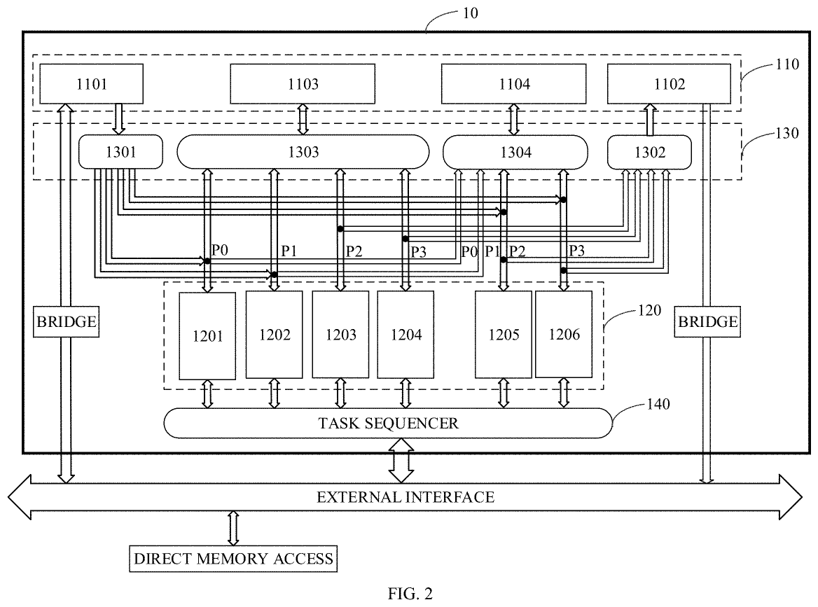

In some implementations, the one or more scratchpad memory units may include a first vector-memory-unit and a second vector-memory-unit. Specifically, as illustrated in FIG. 2, based on the device 10 for shared memory processing illustrated in FIG. 1, the set of shared memory units 110 may include an input memory unit 1101, an output memory unit 1102, a first vector-memory-unit 1103, and a second vector-memory-unit 1104. The set of global clock synchronizers 130 include a first global-clock-synchronizer 1301, a second global-clock-synchronizer 1302, a third global-clock-synchronizer 1303, and a fourth global-clock-synchronizer 1304.

The input memory unit 1101 is coupled with K1 processing units via the first global-clock-synchronizer 1301, the output memory unit 1102 is coupled with K2 processing units via the second global-clock-synchronizer 1302, the first vector-memory-unit 1103 is coupled with K3 processing units via the third global-clock-synchronizer 1303, and the second vector-memory-unit 1104 is coupled with K4 processing units via the fourth global-clock-synchronizer 1304, where K1, K2, K3, and K4 are positive integers less than or equal to N.

In implementations of the disclosure, the global clock synchronizer (grant clock synchronizer, GC-Sync) may also be regarded as an arbiter, and is configured to resolve access conflicts between multiple processing units coupled with a same shared memory unit by assigning each of the multiple processing units to perform memory access during one of different clocks, so as to achieve conflict-free memory access.

For the device 10 for shared memory processing illustrated in FIG. 2, specifically, the first global-clock-synchronizer 1301 is configured to achieve conflict-free memory access of the coupled K1 processing units to the input memory unit 1101 during one instruction cycle. The second global-clock-synchronizer 1302 is configured to achieve conflict-free memory access of the coupled K2 processing units to the output memory unit 1102 during one instruction cycle. The third global-clock-synchronizer 1303 is configured to achieve conflict-free memory access of the coupled K3 processing units to the first vector-memory-unit 1103 during one instruction cycle. The fourth global-clock-synchronizer 1304 is configured to achieve conflict-free memory access of the coupled K4 processing units to the second vector-memory-unit 1104 during one instruction cycle.

It is to be further noted that, as illustrated in FIG. 2, for the two input ports of the input memory unit 1101, the first input-port is coupled with the external interface, and the second input-port is coupled with the K1 processing units via the first global-clock-synchronizer 1301. For the two output ports of the output memory unit 1102, the first output-port is coupled with the external interface, and the second output-port is coupled with the K2 processing units via the second global-clock-synchronizer 1302. The external interface herein may be NOC/AHB/multi core-interconnect, etc., which is not limited in implementations of the disclosure.

In addition, since a protocol for the external interface is different from a protocol for the first input-port and a protocol for the first output-port. In the case, there is an interface conversion component between the external interface and the first input-port and an interface conversion component between the external interface and the first output-port. Therefore, in some implementations, as illustrated in FIG. 2, a bridge is serially coupled between the first input-port and the external interface, and a bridge is serially coupled between the first output-port and the external interface. The bridge here is mainly configured to achieve conversion of interface protocols.

In other words, in FIG. 2, with dual-port RAM design in implementations of the disclosure, when an external device performs DMA to exchange data with the device 10 for shared memory processing through the external interface, data reading and data writing of the processing unit in the device 10 for shared memory processing can be isolated from interaction with external data, and thus it can be ensured that data reading and data writing of the processing unit in the device 10 for shared memory processing are not affected by interaction with external data.

In some implementations, the set of processing units 120 may include the at least one signal processing unit and/or the at least one hardware accelerating unit.

As illustrated in FIG. 2, the at least one signal processing unit may include a first vector-signal-processing-unit 1201, a second vector-signal-processing-unit 1202, a third vector-signal-processing-unit 1203, and a fourth vector-signal-processing-unit 1204. The at least one hardware accelerating unit may include a first hardware-accelerating-unit 1205 and a second hardware-accelerating-unit 1206.

In the case, assuming that one instruction cycle includes four clocks, the K1 processing units coupled with the input memory unit 1101 may include four processing units, i.e., the first vector-signal-processing-unit 1201, the second vector-signal-processing-unit 1202, the first hardware-accelerating-unit 1205, and the second hardware-accelerating-unit 1206, the K2 processing units coupled with the output memory unit 1102 may include four processing units, i.e., the third vector-signal-processing-unit 1203, the fourth vector-signal-processing-unit 1204, the first hardware-accelerating-unit 1205, and the second hardware-accelerating-unit 1206, the K3 processing units coupled with the first vector-memory-unit 1103 may include four processing units, i.e., the first vector-signal-processing-unit 1201, the second vector-signal-processing-unit 1202, the third vector-signal-processing-unit 1203, and the fourth vector-signal-processing-unit 1204, and the K4 processing units coupled with the second vector-memory-unit 1104 may include four processing units, i.e., the first vector-signal-processing-unit 1201, the second vector-signal-processing-unit 1202, the first hardware-accelerating-unit 1205, and the second hardware-accelerating-unit 1206. In this case, the four global clock synchronizers are respectively illustrated as follows. The first global-clock-synchronizer 1301 is configured to achieve conflict-free memory access of the first vector-signal-processing-unit 1201, the second vector-signal-processing-unit 1202, the first hardware-accelerating-unit 1205, and the second hardware-accelerating-unit 1206 to the input memory unit 1101 during one instruction cycle. The second global-clock-synchronizer 1302 is configured to achieve conflict-free memory access of the third vector-signal-processing-unit 1203, the fourth vector-signal-processing-unit 1204, the first hardware-accelerating-unit 1205, and the second hardware-accelerating-unit 1206 to the output memory unit 1102 during one instruction cycle. The third global-clock-synchronizer 1303 is configured to achieve conflict-free memory access of the first vector-signal-processing-unit 1201, the second vector-signal-processing-unit 1202, the third vector-signal-processing-unit 1203, and the fourth vector-signal-processing-unit 1204 to the first vector-memory-unit 1103 during one instruction cycle. The fourth global-clock-synchronizer 1304 is configured to achieve conflict-free memory access of the first vector-signal-processing-unit 1201, the second vector-signal-processing-unit 1202, the first hardware-accelerating-unit 1205, and the second hardware-accelerating-unit 1206 to the second vector-memory-unit 1104 during one instruction cycle.

In other words, as illustrated in FIG. 2, for the first vector-memory-unit 1103, the one instruction cycle includes four clocks, such as clock P0, clock P1, clock P2, and clock P3. Specifically, the first vector-signal-processing-unit 1201 accesses the first vector-memory-unit 1103 via the third global-clock-synchronizer 1303 during clock P0. The second vector-signal-processing-unit 1202 accesses the first vector-memory-unit 1103 via the third global-clock-synchronizer 1303 during clock P1. The third vector-signal-processing-unit 1203 accesses the first vector-memory-unit 1103 via the third global-clock-synchronizer 1303 during clock P2. The fourth vector-signal-processing-unit 1204 accesses the first vector-memory-unit 1103 via the third global-clock-synchronizer 1303 during clock P3. Similarly, for the second vector-memory-unit 1104, the one instruction cycle also includes four clocks, such as clock P0, clock P1, clock P2, and clock P3. Specifically, the first vector-signal-processing-unit 1201 accesses the second vector-memory-unit 1104 via the fourth global-clock-synchronizer 1304 during clock P0. The second vector-signal-processing-unit 1202 accesses the second vector-memory-unit 1104 via the fourth global-clock-synchronizer 1304 during clock P1. The first hardware-accelerating-unit 1205 accesses the second vector-memory-unit 1104 via the fourth global-clock-synchronizer 1304 during clock P2. The second hardware-accelerating-unit 1206 accesses the second vector-memory-unit 1104 via the fourth global-clock-synchronizer 1304 during clock P3. In this way, each shared memory unit can be coupled with four processing units at most to adapt to an instruction cycle including four clocks, such that each of the processing units can access a corresponding shared memory unit during one of four different clocks of one instruction cycle, thereby realizing conflict-free memory access of the four processing units.

In implementations of the disclosure, the device 10 for shared memory processing may be regarded as a vector signal processing sub-system or a vector processing cluster (VPC). The device 10 for shared memory processing may include the set of shared memory units 110 (or called a set of vector memories (VMEMs)), the set of processing units 120 (or called a set of vector digital signal processors (VDSPs) and/or a set of hardware accelerators (HWAs)), the set of global clock synchronizers 130, the TS 140, and a coupling between each specific set of processing units and a corresponding shared memory unit. The details are illustrated in FIG. 2.

In other words, the device 10 for shared memory processing may be constituted by four VMEMs, four VDSPs, two HWAs, four global clock synchronizers, a specific coupling between each of the VMEMs and different VDSPs/HWAs, and the TS. The number of the processing units coupled with each VMEM does not exceed four to adapt to an instruction cycle having four clocks for the processing units. The input memory unit 1101 (i.e., input VMEM) can be accessed by the first vector-signal-processing-unit 1201 (VDSP1), the second vector-signal-processing-unit 1202 (VDSP2), the first hardware-accelerating-unit 1205 (HWA1), and the second hardware-accelerating-unit 1206 (HWA2). The first vector-memory-unit 1103 (i.e., scratch VMEM A) can be accessed by the first vector-signal-processing-unit 1201 (VDSP1), the second vector-signal-processing-unit 1202 (VDSP2), the third vector-signal-processing-unit 1203 (VDSP3), and the fourth vector-signal-processing-unit 1204 (VDSP4). The second vector-memory-unit 1104 (scratch VMEM B) can be accessed by the first vector-signal-processing-unit 1201 (VDSP1), the second vector-signal-processing-unit 1202 (VDSP2), the first hardware-accelerating-unit 1205 (HWA1), and the second hardware-accelerating-unit 1206 (HWA2). The output memory unit 1102 (i.e., output VMEM) can be accessed by the third vector-signal-processing-unit 1203 (VDSP3), the fourth vector-signal-processing-unit 1204 (VDSP4), the first hardware-accelerating-unit 1205 (HWA1), and the second hardware-accelerating-unit 1206 (HWA2). It is to be further noted that each of the processing units (VDSPs and/or HWAs) may further include a memory register (MR).

The VDSP and the HWA both are data processing units, are responsible for reading data from the shared memory unit and processing read data, and then writing results into the shared memory unit. The TS is responsible for receiving a task message transmitted from outside and assigning the task message to a specific processing unit (VDSP or HWA).

The set of shared memory units 110 may include one input memory (i.e., the input memory unit 1101), one output memory (i.e., the output memory unit 1102), and some scratchpad memories (such as the first vector-memory-unit 1103 and the second vector-memory-unit 1104). The input memory and the output memory are dual-port RAMs, where one port is directly coupled with the NOC, and the other port is coupled with specific processing units in the device 10 for shared memory processing. The NOC may carry various system data and has relatively strong randomness, such that data interaction between outside and inside of the device through DMA may be interrupted at any time. However, with the dual-port RAM design, data reading and data writing of the processing unit in the device can be isolated from interaction with external data, and thus it can be ensured that data reading and data writing of the processing unit in the device are not affected by interaction with external data. Each of the VMEMs can be coupled with four processing units at most to adapt to an instruction cycle including four clocks for the VDSPs. In this way, the four processing units will not have memory access conflicts if each of the VDSPs accesses the VMEM in one of four different clocks of one instruction cycle.

It is to be further noted that, the memory is coupled with specific processors such that it can be ensured that each shared memory unit can be accessed by N processing units at most, and the N processing units are synchronous in timing sequence, thereby realizing conflict-free access of the N processing units to a specific shared memory unit in N different clocks of a same instruction cycle.

In implementations of the disclosure, the global clock synchronizer can be responsible for resolving access conflicts between multiple processing units coupled with a same shared memory unit by assigning each of the processing units to perform memory access during one of different clocks, so as to ensure the orthogonality of memory access of the processing units. In this way, the processing can be simplified in the case that the number of the processing units coupled with the global clock synchronizer is less than or equal to the number of clocks of one instruction cycle, that is, the global clock synchronizer performs conflict resolution only when memory access conflict occurs for the first time. After the conflict occurring for the first time is resolved, timing sequence synchronization can be achieved subsequently, and the processing units will not have memory access conflicts.

In some implementations, for the device 10 for shared memory processing illustrated in FIG. 1 or FIG. 2, each global clock synchronizer may include a global counter (not illustrated in the drawings). The global counter is configured to control a memory-access slot assigned to each of the coupled K processing units, and a corresponding count value is increased by one during each clock. When the count value fulfills K-1, the count value is cleared and the global counter recounts.

Furthermore, the global clock synchronizer is configured to select to respond to an access request from an i-th processing unit when the coupled K processing units respectively transmit access requests to a corresponding shared memory unit, in response to a status signal received from the i-th processing unit being at a high level and the count value of the global counter being equal to i.

Furthermore, the global clock synchronizer is configured to delay an instruction corresponding to the access request by one clock and keep the status signal of the i-th processing unit at the high level when the coupled K processing units respectively transmit access requests to a corresponding shared memory unit, in response to the status signal received from the i-th processing unit being at the high level and the count value of the global counter being not equal to i.

Here, i represents an index value of the i-th processing unit, and i is a positive integer less than or equal to K.

In other words, for a certain shared memory unit, the global clock synchronizer can maintain the memory-access slot assigned to each of the processing units via one global counter (grant counter), where the count value of the global counter increases one during each clock, and the global counter recounts from 0 when the count value fulfills K-1 (K is the number of the processing units coupled with the shared memory unit). When one or more processing units need to access the shared memory unit, a corresponding status signal (which can be represented by COREn_RD signal) will be pulled up. Upon reception of the COREn_RD signal, the global clock synchronizer selects to respond to one processing unit according to the current state of the grant counter (which can be reflected by the count value). Specifically, a to-be-responded processing unit needs to meet two conditions: (a) the COREi_RD signal transmitted by the processing unit is at high level; (b) the current count value of the global counter is i. However, if no response is made to a processing unit that transmits a COREn_RD signal request, an internal instruction pipeline for the processing unit is delayed by one clock, and the COREn_RD signal is kept at the high level.

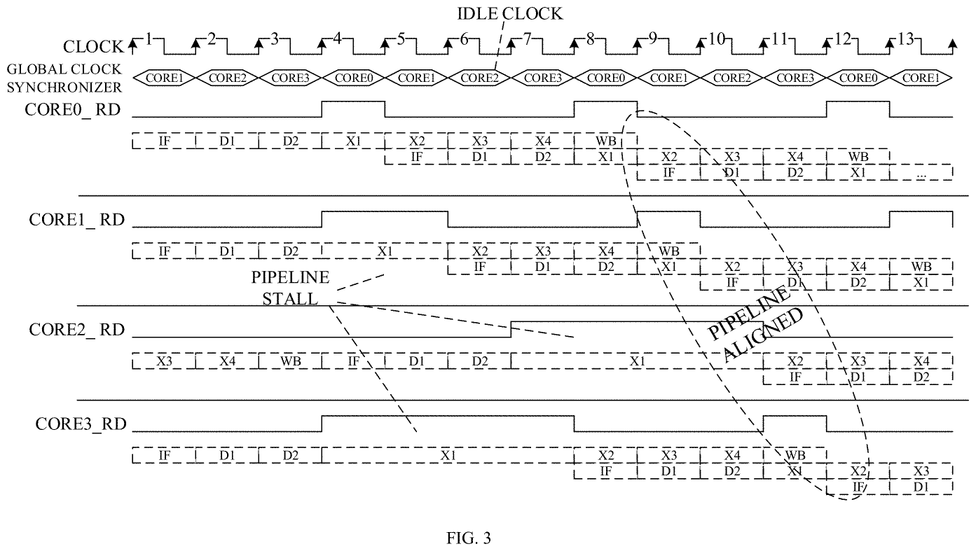

As illustrated in FIG. 3, FIG. 3 is a schematic diagram illustrating working principles of a global clock synchronizer provided in implementations of the disclosure. In FIG. 3, one instruction cycle includes IF, D1, D2, X1, X2, X3, X4, and WB. IF represents instruction fetch, D1 and D2 represent instruction decoding, X1, X2, X3 and X4 represent instruction execution, and WB represents instruction write-back. The X1 stage represents a process of reading (RD), and the WB stage represents a process of writing. Request and response in the RD process will be taken as an example for detailed illustration in the following.

As illustrated in FIG. 3, for a case where there are four processing units, a status signal of a n-th processing unit is represented by COREn_RD signal, and n is 0, 1, 2, or 3. In an initial state, access requests of the four processing units are not synchronized. It can be seen from FIG. 3 that, the 0th processing unit, the 1st processing unit, and the 3rd processing unit simultaneously send access requests for shared memory access in a fourth clock, that is, the three processing units have an access conflict at this time, i.e., pipeline stall. According to the count value of the global counter, it can be seen that, in the current fourth clock, the count value is equal to 0, and the CORE0_RD signal received from the 0th processing unit (CORE0) is at the high level, which indicates that only the 0th processing unit is responded to in the fourth clock. After delaying the pipeline by one clock, according to the count value of the global counter, it can be seen that, in the current fifth clock, the count value is 1, and the CORE1_RD signal received from the 1st processing unit (CORE1) is at the high level, which indicates that only the 1st processing unit is responded to in the fifth clock. After delaying the pipeline by one clock further, according to the count value of the global counter, it can be seen that, in the current sixth clock, the count value is 2, and the CORE2_RD signal received from the 2nd processing unit (CORE2) is at the low level, which indicates that no processing unit is responded to in the sixth clock, i.e., the sixth clock is an idle clock. After delaying the pipeline by one clock further, according to the count value of the global counter, it can be seen that, in the current seventh clock, the count value is 3, and the status signal received from the 3rd processing unit (CORE3) is at the high level, which indicates that only the 3rd processing unit is responded to in the seventh clock. In other words, the global clock synchronizer responds to access requests of the three processing units (i.e., the 0th processing unit, the 1st processing unit, and the 3rd processing unit) in the fourth, the fifth, and the seventh clock, respectively. For the 2nd processing unit, the 2nd processing unit sends the VMEM access request in the seventh clock, and the CORE2_RD signal is at the high level at this time, but according to the count value of the global counter, it can be seen that, only in a tenth clock the count value is 2 and the status signal received from the 2nd processing unit (CORE2) is at the high level, which indicates that the global clock synchronizer responds to the 2nd processing unit in the tenth clock.

In combination with the working principles illustrated in FIG. 3, in the above round of the request-respond process, instruction pipelines for the 0th processing unit, the 1st processing unit, the 2nd processing unit, and the 3rd processing unit are delayed by 0, 1, 3, and 3 clocks respectively, as illustrated in the X1 stage in FIG. 3. Moreover, after that the global clock synchronizer synchronizes the requests of the four processing units, in a new round of the memory access cycle, the four processing units may be responded to in the 8th, 9th, 10th, and 11th clocks respectively. In the case, the four processing units are pipeline aligned, i.e., shared memory accesses of the four processing units are in an orthogonal state, and the four processing units will not have access conflicts.

In some implementations, all units of the device 10 for shared memory processing can be integrated in a same chip. All units, i.e., the set of shared memory units 110, the set of processing units 120, the set of global synchronizer 130, and the TS 140, etc., can be integrated in a same chip.

Briefly, in implementations of the disclosure, by means of dividing the shared memory (such as divided into the input memory unit, the output memory unit, and the one or more scratchpad memory units), each shared memory unit is only coupled with and accessed by processing units, where the number of the processing units is adapted to the number of clocks of an instruction cycle for the processing units, which can avoid memory access conflicts between the processing units to the greatest extent. Moreover, the input/output memory unit adopts a dual-port structure, such that data processing in the device 10 for shared memory processing can be isolated from interaction with external data, thereby eliminating the interference to internal access to the shared memory in the device and the interference of the internal access to the input memory unit and the output memory unit in the device to the external data. In addition, access of processing units coupled with a same shared memory unit to the shared memory unit may be orthogonal via the global clock synchronizer.

The device for shared memory processing is provided in implementations of the disclosure. The device for shared memory processing includes the set of shared memory units, the set of processing units, and the set of global clock synchronizers. Each shared memory unit corresponds to one global clock synchronizer and is coupled with K processing units via the corresponding global clock synchronizer. The coupled K processing units perform conflict-free memory access to the shared memory unit during one instruction cycle. One instruction cycle of the global clock synchronizer includes N clocks, K is less than or equal to N, and K and N are integers greater than zero. In this way, on one hand, in the device for shared memory processing, multiple processing units can perform conflict-free memory access to a same shared memory unit, such that the device for shared memory processing is easy to be extended, and therefore modems that have different processing capacity levels can be achieved by means of increasing the number of devices for shared memory processing; on the other hand, the access to the shared memory unit in the device for shared memory processing can be isolated from access of external data, thereby eliminating the interference to internal access to the shared memory unit in the device for shared memory processing and the interference of the input/output memory unit to external data. In addition, since the device for shared memory processing realizes efficient and conflict-free memory access, the processing delay is stable and can be predicted, and the processing efficiency is improved.

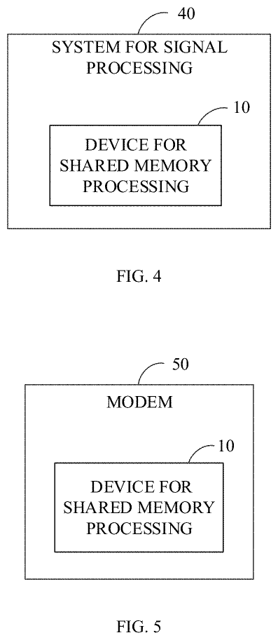

Referring to FIG. 4, FIG. 4 is a schematic structural diagram of a system for signal processing provided in implementations of the disclosure. As illustrated in FIG. 4, a system 40 for signal processing may include at least one device 10 for shared memory processing of any one of implementations mentioned above.

Referring to FIG. 5, FIG. 5 is a schematic structural diagram of a modem provided in implementations of the disclosure. As illustrated in FIG. 5, a modem 50 may include at least one device 10 for shared memory processing of any one of implementations mentioned above.

It is to be noted that, the device 10 for shared memory processing can be regarded as a vector signal processing sub-system, or called VPC. Multiple devices for shared memory processing can constitute the system 40 for signal processing. Moreover, the system 40 for signal processing not only has high processing capacity, but also can flexibly and rapidly make changes according to different capacity levels.

It is to be further noted that, for the device 10 for shared memory processing, the most significant feature is that all processing units in the device can access the shared memory unit without conflict, and with dual-port design, internal access to the shared memory unit in the device can be isolated from access of external data, such that the device has high processing efficiency and stable and predictable processing delay, and is easy to be extended. In this way, modems that have different processing capacities can be realized rapidly by means of connecting different numbers of the devices 10 for shared memory processing with NOC of the modem 50.

In implementations of the disclosure, the processing units in the device can perform conflict-free access, which is not affected by external NOC data flow, and also does not affect data transmission of the NOC. Therefore, modems that have different capacity levels can be realized stably and rapidly by means of increasing the number of the devices simply, and thus rapid customization of the modem 50 having different capacities can be realized. Moreover, in the device 10 for shared memory processing, each of the processors in the device can perform conflict-free access to the shared memory via division of the shared memory, the dual-port input/output RAM, the coupling between specific processors and the memory, and the global clock synchronizer, etc. Additionally, because of conflict-free memory access, processing timing for the device may be computable and predictable, the device is stable and can be extended, so as to achieve efficient and conflict-free memory access, which is of great significance for rapid design of an efficient and stable modem.

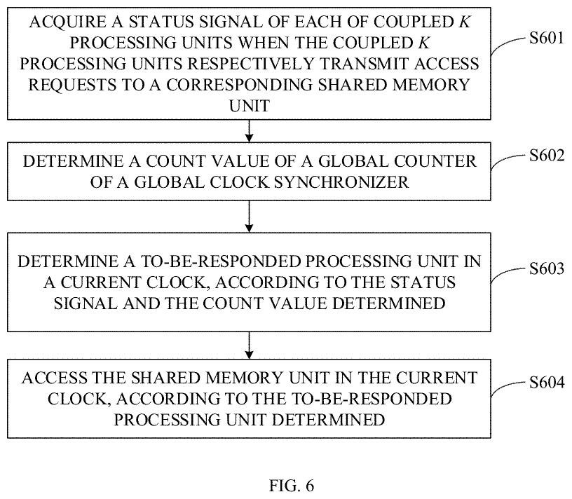

Referring to FIG. 6, FIG. 6 is a flow chart of a method for shared memory processing provided in implementations of the disclosure. As illustrated in FIG. 6, the method may include the following.

At S601, acquire a status signal of each of coupled K processing units when the coupled K processing units respectively transmit access requests to a corresponding shared memory unit.

At S602, determine a count value of a global counter of a global clock synchronizer.

At S603, determine a to-be-responded processing unit in a current clock, according to the status signal and the count value determined.

At S604, access the shared memory unit in the current clock, according to the to-be-responded processing unit determined.

It is to be noted that, the method for shared memory processing is applicable to the device 10 for shared memory processing of any one of implementations mentioned above. The device 10 for shared memory processing may include the set of shared memory units, the set of processing units, and the set of global clock synchronizers. Each shared memory unit corresponds to one global clock synchronizer and is coupled with K processing units via the corresponding global clock synchronizer. The coupled K processing units can perform conflict-free memory access to the shared memory unit during one instruction cycle. The one instruction cycle of the global clock synchronizer includes N clocks, K is less than or equal to N, and K and N are integers greater than zero.

It is to be further noted that the number of the processing units coupled with each shared memory unit is related to the instruction cycle of the global clock synchronizer. Assuming that one instruction cycle includes four clocks, the number of the processing units coupled with each shared memory unit does not exceed four. In the case, for a certain shared memory unit, each of corresponding processing units accesses the shared memory unit during one of four different clocks of one instruction cycle, and thus there will be no memory access conflict.

In some implementations, the set of shared memory units may include at least three shared memory units, and the at least three shared memory units may include the input memory unit, the output memory unit, and the one or more scratchpad memory units.

The input memory unit adopts a dual-port structure, and the output memory unit adopts a dual-port structure, such that data reading and data writing of the processing unit in the device 10 for shared memory processing can be isolated from interaction with external data, and thus it can be ensured that data reading and data writing of the processing unit in the device 10 for shared memory processing are not affected by interaction with external data.

In some implementations, the set of processing units may include at least one signal processing unit and/or at least one hardware accelerating unit.

Both the signal processing unit and the hardware accelerating unit belong to data processing units. The signal processing unit and the hardware accelerating unit are both responsible for reading data from a corresponding shared memory unit, processing read data, and then writing processing results to the shared memory unit.

It is to be further noted that, for the set of processing units, to adapt to an instruction cycle including N different clocks, a shared memory unit is coupled with specific processing units, such that it can be ensured that each shared memory unit can be accessed by N processing units at most, and the N processing units are synchronous in timing sequence, thereby realizing conflict-free access of the N processing units to the shared memory unit in N different clocks of a same instruction cycle.

Furthermore, the device for shared memory processing may further include a TS. The TS is coupled with an external interface and the set of processing units. Therefore, in some implementations, the method further includes receiving a task message transmitted through the external interface, forwarding the task message to a processing unit for execution in the set of processing units via the TS, and performing a task corresponding to the task message via the processing unit for execution.

It is to be noted that the processing unit for execution is a specific processing unit configured to execute the task corresponding to the task message in the set of processing units. The processing unit for execution herein may be the signal processing unit or the hardware accelerating unit, which is not limited in implementations of the disclosure.

It is to be further noted that, the global clock synchronizer can be responsible for resolving access conflicts between multiple processing units coupled with a same shared memory unit by assigning each of the processing units to perform memory access during one of different clocks, so as to ensure the orthogonality of memory access of the processing units. In this way, the processing can be simplified when the number of the processing units coupled with the global clock synchronizer is less than or equal to the number of clocks of the instruction cycle, that is, the global clock synchronizer performs conflict resolution only when memory access conflict occurs for the first time. After the conflict occurring for the first time is resolved, timing sequence synchronization can be achieved subsequently, and the processing units will not have memory access conflict.

In some implementations, each global clock synchronizer may include a global counter. The global counter is configured to control a memory-access slot assigned to each of the coupled K processing units, and a corresponding count value is increased by one during each clock. When the count value fulfills K-1, the count value is cleared and the global counter recounts.

Furthermore, in some implementations, for S603, determining the to-be-responded processing unit in the current clock according to the status signal and the count value determined may include determining an i-th processing unit as the to-be-responded processing unit in the current clock, in response to a status signal of the i-th processing unit being at a high level and the count value determined being equal to i, where i represents an index value of the i-th processing unit, and i is a positive integer less than or equal to K.

Furthermore, in some implementations, the method may include keeping the status signal of the i-th processing unit at the high level and delaying an instruction corresponding to the access request by one clock, in response to the status signal of the i-th processing unit being at the high level and the count value determined being not equal to i; and determining the i-th processing unit as the to-be-responded processing unit in the current clock in response to the count value determined being equal to i, after delaying the instruction by one clock.

It is to be noted that the count value is increased by one when the instruction is delayed by one clock. When the count value fulfills K-1, the count value of the global counter needs to be cleared and the global counter recounts. In this way, after delaying the instruction by one clock, it can be re-determined whether the count value is i and whether the status signal of the i-th processing unit is at the high level. If the count value is not i and/or the status signal of the i-th processing unit is not at the high level, delaying the instruction by one clock is re-executed. If the count value is i and the status signal of the i-th processing unit is at the high level, the i-th processing unit can be determined as the to-be-responded processing unit in the current clock, and then access the shared memory unit in the current clock according to the to-be-responded processing unit determined.

In other words, for a certain shared memory unit, the global clock synchronizer can maintain the memory-access slot assigned to each of the processing units via one global counter, where the count value of the global counter increases one in each clock, and the global counter recounts from 0 when the count value fulfills K-1 (K is the number of the processing units coupled with the shared memory unit). When one or more processing units need to access the shared memory unit, a corresponding status signal (which can be represented by COREn_RD signal) will be pulled up. Upon reception of the COREn_RD signal, the global clock synchronizer selects to respond to one processing unit according to the current state of the grant counter (which can be reflected by the count value). Specifically, a processing unit to-be-responded needs to meet two conditions: (a) the COREi_RD signal transmitted by the processing unit is at high level; (b) the count value of the global counter is i. However, if no response is made to a processing unit that transmits a COREn_RD signal request, an internal instruction pipeline for the processing unit is delayed by one clock, and the COREn_RD signal is kept at the high level.

In combination with the working principles illustrated in FIG. 3, for a case where there are four processing units, instruction pipelines for the 0th processing unit, the 1st processing unit, the 2nd processing unit, and the 3rd processing unit are delayed by 0, 1, 3, and 3 clocks respectively. Moreover, after that the global clock synchronizer synchronizes the requests of the four processing units, in a new round of the memory access cycle, the four processing units may be responded to in the 8th, 9th, 10th, and 11th clocks respectively. In the case, the four processing units are pipeline aligned, i.e., shared memory accesses of the four processing units are in an orthogonal state, and the four processing units will not have access conflict.

The method for shared memory processing is provided in the implementation and applicable to the device for shared memory processing. The method includes acquiring a status signal of each of K processing units when the coupled K processing units respectively transmit access requests to a corresponding shared memory unit; determining a count value of a global counter of a global clock synchronizer; determining the to-be-responded processing unit in the current clock, according to the status signal and the count value determined; accessing the shared memory unit in the current clock, according to the to-be-responded processing unit determined. One instruction cycle of the global clock synchronizer includes N clocks, K is less than or equal to N, and K and N are integers greater than zero. In this way, multiple processing units can perform conflict-free memory access to a same shared memory unit in the device for shared memory processing, such that the device for shared memory processing is easy to be extended, and therefore modems that have different processing capacity levels can be achieved by means of increasing the number of the devices for shared memory processing. Moreover, internal access to the shared memory unit in the device for shared memory processing can be isolated from access of external data, thereby eliminating the interference to the internal access to the shared memory unit in the device for shared memory processing and the interference of the input/output memory unit to the external data. In addition, since the device for shared memory processing realizes efficient and conflict-free memory access, the processing delay may be stable and predictable, and the processing efficiency is improved.

It could be understood that, the device 10 for shared memory processing provided in implementations of the disclosure may be an integrated circuit chip with signal processing capacity. During implementation, each step of the foregoing implementations of the method may be completed by combining an integrated logic circuit in the form of hardware in the device 10 for shared memory processing with an instruction in the form of software. Based on such understanding, some functions of the technical solution of the disclosure can be embodied in the form of software products. Therefore, a computer storage medium storing a computer program is provided in the implementation. Steps of the method for shared memory processing of the foregoing implementations are performed when the computer program is performed by the device for shared memory processing.

Those of ordinary skill in the art will appreciate that units and algorithmic operations of various examples described in connection with implementations of the disclosure can be implemented by electronic hardware or by a combination of computer software and electronic hardware. Whether these functions are performed by means of hardware or software depends on the specific application and the design constraints of the technical solution. Those skilled in the art may use different methods with regard to each particular application to implement the described functionality, but such implementation should not be regarded as lying beyond the scope of the disclosure.

It will be evident to those skilled in the art that, for the sake of convenience and simplicity, in terms of the working processes of the foregoing systems, devices, and units, reference can be made to the corresponding processes of the above method implementations, which will not be repeated herein.

It is to be noted that, in the disclosure, the term “comprise” and “contain” as well as variations thereof are intended to cover non-exclusive inclusion, so that a process, method, article or device including a series of elements not only includes those elements, but also includes other elements not explicitly listed, or also includes elements inherent to such process, method, article or device. Without further restrictions, the element defined by the statement “including one . . . ” does not exclude the existence of another identical element in the process, method, article or device including the element.

The serial number of implementations of the disclosure is only for illustration and does not represent the advantages and disadvantages of implementations.

The methods disclosed in several method implementations provided in the disclosure can be combined arbitrarily to obtain new method implementations without conflict.

The features disclosed in several product implementations provided in the disclosure can be combined arbitrarily to obtain new product implementations without conflict.

The features disclosed in several method or device implementations provided in the disclosure can be combined arbitrarily to obtain new method implementations or device implementations without conflict.

The above is only the specific implementations of the disclosure, but the protection scope of the disclosure is not limited to the above. Any skilled in the technical field can easily think of changes or replacements within the technical scope of the disclosure, and the changes or replacements should fall in the protection scope of the disclosure. Therefore, the protection scope of the disclosure shall be subject to the protection scope of the claims.

### INDUSTRIAL APPLICABILITY

In implementations of the disclosure, multiple processing units can perform conflict-free memory access to a same shared memory unit in the device for shared memory processing, such that the device for shared memory processing is easy to be extended, and therefore modems that have different processing capacity levels can be achieved by means of increasing the number of the devices for shared memory processing. Moreover, internal access to the shared memory unit in the device for shared memory processing can be isolated from access of external data, thereby eliminating the interference to the internal access to the shared memory unit in the device for shared memory processing and the interference of the input/output memory unit to the external data. In addition, since the device for shared memory processing realizes efficient and conflict-free memory access, the processing delay may be stable and predictable, and the processing efficiency is improved.

What is claimed is:

1. A device for shared memory processing, comprising:
a set of shared memory units;
a set of processing units; and
a set of global clock synchronizers;
wherein each shared memory unit corresponds to one global clock synchronizer and is coupled with K processing units via the corresponding global clock synchronizer, and the coupled K processing units perform conflict-free memory access to the shared memory unit during one instruction cycle of the corresponding global clock synchronizer, wherein one instruction cycle of each global clock synchronizer comprises N clocks, K is less than or equal to N, and K and N are integers greater than zero.

2. The device of claim 1, wherein the set of shared memory units comprise at least three shared memory units, and the at least three shared memory units comprise an input memory unit, an output memory unit, and one or more scratchpad memory units.

3. The device of claim 2, wherein:
the one or more scratchpad memory units comprise a first vector-memory-unit and a second vector-memory-unit, and the set of global clock synchronizers comprise a first global-clock-synchronizer, a second global-clock-synchronizer, a third global-clock-synchronizer, and a fourth global-clock-synchronizer; and
the input memory unit is coupled with K1 processing units via the first global-clock-synchronizer, the output memory unit is coupled with K2 processing units via the second global-clock-synchronizer, the first vector-memory-unit is coupled with K3 processing units via the third global-clock-synchronizer, and the second vector-memory-unit is coupled with K4 processing units via the fourth global-clock-synchronizer, wherein K1, K2, K3, and K4 are positive integers less than or equal to N.

4. The device of claim 3, wherein:
the first global-clock-synchronizer is configured to achieve conflict-free memory access of the coupled K1 processing units to the input memory unit during one instruction cycle;
the second global-clock-synchronizer is configured to achieve conflict-free memory access of the coupled K2 processing units to the output memory unit during one instruction cycle;
the third global-clock-synchronizer is configured to achieve conflict-free memory access of the coupled K3 processing units to the first vector-memory-unit during one instruction cycle; and
the fourth global-clock-synchronizer is configured to achieve conflict-free memory access of the coupled K4 processing units to the second vector-memory-unit during one instruction cycle.

5. The device of claim 3, wherein:
the input memory unit adopts a dual-port structure, and the output memory unit adopts a dual-port structure;
the input memory unit comprises a first input-port and a second input-port, wherein the first input-port is coupled with an external interface, and the second input-port is coupled with the K1 processing units via the first global-clock-synchronizer; and
the output memory unit comprises a first output-port and a second output-port, wherein the first output-port is coupled with the external interface, and the second output-port is coupled with the K2 processing units via the second global-clock-synchronizer.

6. The device of claim 3, wherein the set of processing units comprise at least one signal processing unit and/or at least one hardware accelerating unit.

7. The device of claim 3, wherein at least one processing unit in the K1 processing units is the same as at least one processing unit in the K2 processing units, at least one processing unit in the K1 processing units is the same as at least one processing unit in the K3 processing units, and at least one processing unit in the K1 processing units is the same as at least one processing unit in the K4 processing units.

8. The device of claim 1, further comprising a task sequencer, wherein:
the task sequencer is coupled with an external interface and the set of processing units; and
the task sequencer is configured to receive a task message transmitted through the external interface and forward the task message to a corresponding processing unit.

9. The device of claim 1, wherein each of the global clock synchronizers comprises a global counter;
wherein the global counter is configured to control a memory-access slot assigned to each of the coupled K processing units, and a corresponding count value is increased by one during each clock, and when the count value fulfills K-1, the count value is cleared and the global counter recounts.

10. The device of claim 9, wherein the global clock synchronizer is configured to select to respond to an access request of an i-th processing unit when the coupled K processing units respectively transmit access requests to the corresponding shared memory unit, in response to a status signal received from the i-th processing unit being at a high level and the count value of the global counter being equal to i, wherein i represents an index value of the i-th processing unit, and i is a positive integer less than or equal to K.

11. The device of claim 10, wherein the global clock synchronizer is further configured to delay an instruction corresponding to the access request by one clock and keep the status signal of the i-th processing unit at the high level when the coupled K processing units respectively transmit the access requests to the corresponding shared memory unit, in response to the status signal received from the i-th processing unit being at the high level and the count value of the global counter being not equal to i.

12. The device of claim 1, wherein all units of the device for shared memory processing are integrated in a same chip.

13. A method for shared memory processing applicable to a device for shared memory processing, the device for shared memory processing comprising a set of shared memory units, a set of processing units, and a set of global clock synchronizers; each shared memory unit corresponding to one global clock synchronizer and being coupled with K processing units via the corresponding global clock synchronizer; and the method comprising:
acquiring a status signal of each of the K processing units when the coupled K processing units respectively transmit access requests to the corresponding shared memory unit;
determining a count value of a global counter of the corresponding global clock synchronizer;
determining a to-be-responded processing unit in a current clock, according to the status signal and the count value determined; and
accessing the shared memory unit in the current clock, according to the to-be-responded processing unit determined;
wherein one instruction cycle of each global clock synchronizer comprises N clocks, K is less than or equal to N, and K and N are positive integers.

14. The method of claim 13, wherein determining the to-be-responded processing unit in the current clock according to the status signal and the count value determined, comprises:
determining an i-th processing unit as the to-be-responded processing unit in the current clock, in response to a status signal of the i-th processing unit being at a high level and the count value determined being equal to i, wherein i represents an index value of the i-th processing unit, and i is a positive integer less than or equal to K.

15. The method of claim 14, further comprising:
keeping the status signal of the i-th processing unit at the high level and delaying an instruction corresponding to an access request of the i-th processing unit by one clock, in response to the status signal of the i-th processing unit being at the high level and the count value determined being not equal to i; and
determining the i-th processing unit as the to-be-responded processing unit in the current clock in response to the count value determined being equal to i, after delaying the instruction by one clock.

16. The method of claim 13, further comprising:
receiving a task message transmitted through an external interface;
forwarding the task message to a processing unit for execution in the set of processing units via a task sequencer of the device for shared memory processing; and
performing a task corresponding to the task message via the processing unit for execution.

17. A non-transitory computer storage medium storing a computer program, the computer program being executed by a device for shared memory processing, the device for shared memory processing comprising a set of shared memory units, a set of processing units, and a set of global clock synchronizers, each shared memory unit corresponding to one global clock synchronizer and being coupled with K processing units via the corresponding global clock synchronizer, and the computer program being executed by the device for shared memory processing to perform:
acquiring a status signal of each of the K processing units when the coupled K processing units respectively transmit access requests to the corresponding shared memory unit;
determining a count value of a global counter of the corresponding global clock synchronizer;
determining a to-be-responded processing unit in a current clock, according to the status signal and the count value determined; and
accessing the shared memory unit in the current clock, according to the to-be-responded processing unit determined;
wherein one instruction cycle of each global clock synchronizer comprises N clocks, K is less than or equal to N, and K and N are positive integers.

18. The non-transitory computer storage medium of claim 17, wherein determining the to-be-responded processing unit in the current clock according to the status signal and the count value determined, comprises:
determining an i-th processing unit as the to-be-responded processing unit in the current clock, in response to a status signal of the i-th processing unit being at a high level and the count value determined being equal to i, wherein i represents an index value of the i-th processing unit, and i is a positive integer less than or equal to K.

19. The non-transitory computer storage medium of claim 18, wherein the computer program is further executed by the device for shared memory processing to perform:
keeping the status signal of the i-th processing unit at the high level and delaying an instruction corresponding to an access request of the i-th processing unit by one clock, in response to the status signal of the i-th processing unit being at the high level and the count value determined being not equal to i; and
determining the i-th processing unit as the to-be-responded processing unit in the current clock in response to the count value determined being equal to i, after delaying the instruction by one clock.

20. The non-transitory computer storage medium of claim 17, wherein the computer program is further executed by the device for shared memory processing to perform:
receiving a task message transmitted through an external interface;
forwarding the task message to a processing unit for execution in the set of processing units via a task sequencer of the device for shared memory processing; and
performing a task corresponding to the task message via the processing unit for execution.
